(19) United States
(12) Patent Application Publication
(10) Pub. No.: US 2017/0335868 A1
(43) Pub. Date: Nov. 23, 2017

(54) SYSTEM AND METHOD FOR MAGNETIC SUSPENSION OF LABORATORY OBJECTS

(71) Applicant: Lester Smith Medical Research Institute, San Antonio, TX (US)

(72) Inventors: Ramon Coronado, San Antonio, TX (US); Lauren E. Cornell, San Antonio, TX (US)

(73) Assignee: Lester Smith Medical Research Institute, San Antonio, TX (US)

(21) Appl. No.: 15/404,966

(22) Filed: Jan. 12, 2017

Related U.S. Application Data
(60) Provisional application No. 62/339,651, filed on May 20, 2016.

(51) Int. Cl. F16B 1/00; F16M 13/02

(52) U.S. Cl. CPC F16B 1/00; F16M 13/027; F16M 13/022; F16B 2001/0035

(57) ABSTRACT

Disclosed is a system and method for aiding the sterility of a laboratory by suspending items using magnetic force to a laboratory object, such as a cap or a lid, wherein such cap may be suspended on a rack or stand comprising an arm extending horizontally. The system allows for suspension of items rather than placing them on surfaces, which may lead to contamination. The system may further prevent mixing of lids by increasing organizational capability by magnetic suspension of the caps or lids. The disclosed system supports a wide variety of scenarios for laboratory settings and related products and services.

### CROSS-REFERENCE TO RELATED APPLICATIONS

This application claims priority to provisional application 62/339,651, filed May 20, 2016, entitled “SYSTEM AND METHOD FOR MAGNETIC SUSPENSION OF LABORATORY OBJECTS”, which is incorporated by reference herein in its entirety.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### TECHNICAL FIELD

The present invention relates in general to the field of laboratory supplies. In particular, the present invention provides for an improved device for maintaining sterility with glassware, plastic ware, conical tubes, lids, plates and dishes within a laboratory setting. The disclosed embodiments support a wide variety of scenarios for laboratory use and related products.

### STATEMENT OF FEDERALLY FUNDED RESEARCH

None.

### BACKGROUND OF THE DISCLOSURE

In many laboratory settings, instruments and flasks are commonly used which have removable parts such as lids. Items such as flasks, glassware, and other vessels, including test tubes and reaction tubes, are often used in the context of culturing cells, containing reactions, and mixing chemicals. Some flasks, such as volumetric flasks, come with stoppers or caps for capping the opening at the top of the next. Other forms of glassware and plastic ware, such as petri dishes or reaction tubes, have lids which cover the receptacle. These lids must be handled during use, including removal and placement of the lids on surfaces which may be sources of contamination.

Many scenarios require that the lid be removed while the dish, plate, or tube is being handled. Often the lids are placed aside onto a surface. In order to prevent the inside portion of the lid from being possibly contaminated, the lids may be placed with their tops down, resulting in exposure of the inner portion and rim of the lid as the lid rests on the surface. Conversely, lids may also be placed with in the interior face up, exposing the lid interior to contaminants in the air. Other options include resting the lids on their sides, presenting a risk of rolling or falling over. Despite advances in the art, there remains a need to improve the ability to maintain sterility in laboratory equipment such as glassware and associated lids and covers.

### SUMMARY OF THE DISCLOSURE

The present invention addresses limitations in the art by providing an adhesive magnet or magnetic metal, including materials which are paramagnetic, ferromagnetic, ferrimagnetic, and combinations thereof, for affixing to laboratory objects, including lids of petri dishes, culture plates, flasks, tubes and related glassware. For example, when trying to maintain sterility, the lids of various bottles and containers are subject to contamination when removed and placed aside prior to replacing on the applicable container. The present invention provides a magnetized or magnetic sticker and stand capable of conferring magnetization for purposes of suspension of the laboratory object on a stand having a support surface. No edges of the laboratory object are exposed to the work surface, thus retaining sterility. The present invention may also be used outside of tissue culture to hold lids and keep track of which lid goes with which bottle by having a support surface proximally located to the laboratory object being used, or with particular designated sections for labelled objects. Indeed, the present invention can be used on any object that may be suspended during use. The applicable part of the laboratory object, such as a cap or lid, may be magnetized via a magnetic sticker or strip, and may further be autoclavable for repeated use.

It is therefore an object of the present invention to provide a system for suspension of laboratory objects, comprising: a magnet affixed to an object; a stand having a surface support further comprising an arm extending horizontally to a surface wherein said arm further comprises a magnetic lower surface of the arm; wherein the laboratory object is capable of being suspending from the arm via the magnetic lower surface via magnetic force of the arm.

It is another object of the present invention to provide a method of maintaining sterility of a laboratory object comprising: removing a cap from a laboratory object, wherein the cap is capable of being magnetically attached to a neighboring support surface; and suspending the cap from a support surface, wherein the support surface is capable of suspending the laboratory object via magnetic force.

The present invention addresses the limitations of the art by providing a system and method for maintaining sterility of laboratory objects during use, allowing them to be suspended via magnetic force. In another object, the laboratory objects may be suspended from a support surface using adhesive, Velcro, or other fastening means.

The system of the present invention may further include a laboratory object that is selected from the group consisting of: lids, covers, trays, plugs, stoppers, caps, clips, clamps, or any further removable portion of a laboratory object. The system support may be selected from the group consisting of: a stand, a shelf, a wall, a bar, a beam, a peg, a cantilever, a board, and a hood. The support surface may be vertical or horizontal, and the support surface may the ventral surface.

In one aspect, the support surface is magnetized. In another aspect the laboratory object itself is magnetized. The magnets may further comprise a removable magnet is affixed to a laboratory object for suspending from a support surface.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 depicts an exemplary tube having a lid for use in connection with the present invention.

FIG. 2 depicts a magnetic strip having a single adhesive backing for use with the present invention.

FIG. 3 depicts a tube having a lid containing a magnetic strip affixed to the top of the lid, for use in the present invention.

FIG. 4 depicts a schematic of the present invention wherein the magnetic strip is affixed to a lid, which is then positioned to a metal or magnetic support surface.

FIG. 5 depicts a schematic of the present invention wherein the magnetic strip is affixed to a support surface, wherein a magnetic lid is positioned thereon.

### DETAILED DESCRIPTION OF THE DISCLOSURE

While the making and using of various embodiments of the present invention are discussed in detail below, it should be appreciated that the present invention provides many applicable inventive concepts that can be embodied in a wide variety of specific contexts, goods, or services. The specific embodiments discussed herein are merely illustrative of specific ways to make and use the disclosure and do not delimit the scope of the disclosure.

All publications and patent applications mentioned in the specification are indicative of the level of skill of those skilled in the art to which this disclosure pertains. All publications and patent applications are herein incorporated by reference to the same extent as if each individual publication or patent application was specifically and individually indicated to be incorporated by reference.

The present invention will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

For the purposes of the present invention, a “laboratory object” comprises laboratory glassware or materials, including components thereof, including glassware, vials, dishes, trays, tubes, flasks, bowls, crucibles, arrays, wells, plates, plastic ware, reactors, covers, trays, plugs, stoppers, caps, clips, clamps, or any removable portion of a laboratory object. The removable portion of the laboratory object is referred to herein primarily as a “cap” but may be referred to herein as any of the included types of laboratory objects or component thereof.

In one embodiment the present invention comprises a magnetic material, such as a magnet, having a first magnetic side and a second adhesive side which can be affixed on a laboratory object, such as a cap or a lid. The magnets may be comprised of any material which is ferrous, magnetized or magetizable by any means known in the art. The magnets are capable of being stored in a sterile bag which may be opened under sterile conditions or directly in the work space. Once opened the magnet may be affixed to an item and placed upon a magnetic surface of choice, including a magnetic stand of the present invention. In another embodiment, the item having the affixed magnet may be placed on any support surface that is sterile and magnetic within a laboratory. In one embodiment, the magnet affixed to the item may be reusable through repeated sterilizations of the item. In another embodiment, the affixed magnet may be removed and thrown away after one use to maintain sterility.

In another embodiment, lids of an item are comprised of magnetic material, such as a metal insert, for attaching to a magnetized material positioned on a support surface of a rack, stand or shelf. The support surface may comprise a magnetic strip affixed to the support surface, which may further comprise magnetized tape or the use of adhesives. Additionally, inserts within grooved portions or slots may be formed on the support surface of a rack, stand, or shelf, where a magnet or magnetic strip may be inserted and exposed for attachment of objects.

In yet another embodiment, the present invention aids in the sterility of laboratory work by suspending laboratory objects rather than having them touching a potentially contaminated surface. Additionally, the present invention allows for the documentation and tracking of lids when working with multiple containers or vials. As an alternative to placing a lid or cap on a potentially contaminated surface in a “cap-up” or “cap-down” fashion, the present invention allows for suspending lids utilizing a magnetic stand, cantilever, or protrusion from a work station. The present invention may be utilized for a variety of suspension needs beyond that of lids and caps. Rather than investing in expensive magnetic tissue culture caps which need to be reused and could cause alterations to cell growth with long term exposure during incubation, the present invention provides an on demand solution that can be applied just to the lid and removed when done.

Maintaining sterility in laboratory settings is critical, particularly when handling samples of cells or living cultures. Basic tissue culture rules either call for placing a cap up or cap down on a sterile surface, a best practice and primary option taught and practiced amongst the community of sterile laboratory workers.

In another embodiment, the present invention is able to be applied to many devices which undergo repeated sterilizations. Sterile reusables include surgical instruments such as endoscopes and laproscopes, while sterile resposables include devices which were intended for one time use, but are now being considered for re-use. In both cases, repeated sterilization is a requirement. The type of sterilization employed for reusables and resposables, duration of exposure, and maximum number of cycles is expected to vary based on the type of device and use. It is anticipated, however, that methods conducive to quick turn-around and low toxicity will likely be utilized (i.e. autoclaving, hydrogen peroxide, chemical immersion).

Sterilization is defined as the elimination of all living organisms and can be accomplished in a variety of ways. Heat, chemicals and radiation are all methods employed to ensure that medical devices are suitable for human use. Common methods of sterilization include steam autoclave, electron beam, ethylene oxide treatment, gamma radiation, hydrogen peroxide, chemical immersion, and the like. Autoclaving is considered the most common sterilization method, and is often considered the most challenging form of sterilization to device manufacturers, as they must ensure that substrates and fastening methods are able to handle environments such as autoclaving and other sterilization methods. As a result, specialty grades of adhesives are available for products made subject to such processes.

In one embodiment, a removable adhesive backing is utilized with the present invention. In another embodiment a more durable adhesive is used for reusable instruments and devices. Adhesives such as cyanoacrylate, light curing cyanoacrylate, light curing acrylic, dual UV/moisture curable silicone, epoxy and urethane adhesives are commonly used for the assembly of medical devices. Other adhesives include silicones, epoxies, and the like. In general, adhesives offer several benefits over other medical device assembly methods, including the ability to fill large gaps, the ability to bond dissimilar materials, the ability to distribute stress evenly across a bondline, and the ability to form a hermetic seal when confined between two substrates.

Cyanoacrylates form thermoplastic resins when cured. Standard unfilled ethyl monomer based cyanoacrylates typically exhibit low impact and peel strengths, low to moderate solvent resistance, and maximum operating temperatures of 160-180° F. Specialty formulations are now available to address the initial limitations including rubber toughened cyanoacrylates for enhanced impact and peel strengths, low odor/bloom products for minimized frosting, surface insensitive formulations for rapid fixture and cure in low humidity/acidic environments, and thermally resistant products with continuous operating temperatures of 250° F.

Besides advancements in ethyl cyanoacrylate technology, there have also been significant advancements in primer and accelerator formulations which not only offer speed of cure but also the ability to bond “hard-to-bond” plastics. The primers are solvent-based systems which deposit reactive species onto otherwise “dead” substrates. Such reactive species allow for significant increases in bond strength for the majority of difficult to bond materials including polyethylene, polypropylene, fluoropolymer, and acetal homopolymer. A critical factor in maintaining bond strengths with cyanoacrylate adhesives following autoclave exposure lies in the selection of substrates that offer moderate to high initial strengths as well as substrates capable of withstanding the rigorous temperature, pressure and steam environment of the system.

Other advanced adhesives capable of use in rigorous environments include clear, low viscosity epoxies and off-white, medium viscosity urethane adhesives for substrates such as glass, polycarbonate, and polyvinylchloride. Many of the epoxy adhesives are sold as medical grade adhesives, and may be room curable, USP Class VI certified epoxies for repeated sterilization, including autoclaving. The epoxy-based adhesives may be 1-part or 2-part systems, UV/LED curing systems, and the like. Ideally, the adhesive exhibits qualities including but not limited to, biocompatibility (USP Class VI approved), resistance to sterilization, high-bond strength to similar and dissimilar substrates, solvent free, gap filling, thermal stability and fast-curing.

In another embodiment of the present invention, the adhesive is a “peel-and-stick” USP Class VI biocompatible adhesive capable of being affixed to a desired lid. The magnetic portion of the present invention is adhesive-backed, allowing for the magnet to be affixed to a lid for use. The magnets may be peel-and-stick, adhesive backed, self-adhesive, or adhesive magnetic sheets. In an exemplary embodiment of the present invention, the adhesive on the magnet comprises a peel-and-stick USP Class VI adhesive capable of multiple sterilization and reuse.

The present invention further comprises a portable magnetic stand or holder comprising a support surface for suspending the magnetized objects. The stand may be capable of sterilization itself, and, once sterilized, may be placed onto a table or surface such as a laboratory bench for use. The stand may comprise a vertical shaft extending upward from a base. Extending from the shaft is one or more arms extending horizontally from the shaft. The form of the stand may be as a rack, tree, beam, or other formation designed to have magnetized objects suspended from the one or more horizontal extensions, or arms. For organizational purposes, the horizontal arms may further include running grooves for placing adjustable tabs or dividers for purposes of organization of the suspended objects. The tabs may be made from metal, plastic, or rubberized materials. In an alternative embodiment, the tabs may be magnetized themselves for attachment where needed to provide separate zones for organizing the objects to be suspended.

The magnetized stand of the present invention may further be adjustable via joints, telescopic shafts and arms, swivels, and clamps. In another embodiment, the stand may be itself suspended from a shelf, hood, or ceiling for purposes of providing a magnetized support surface for suspension of objects, instruments, and the like.

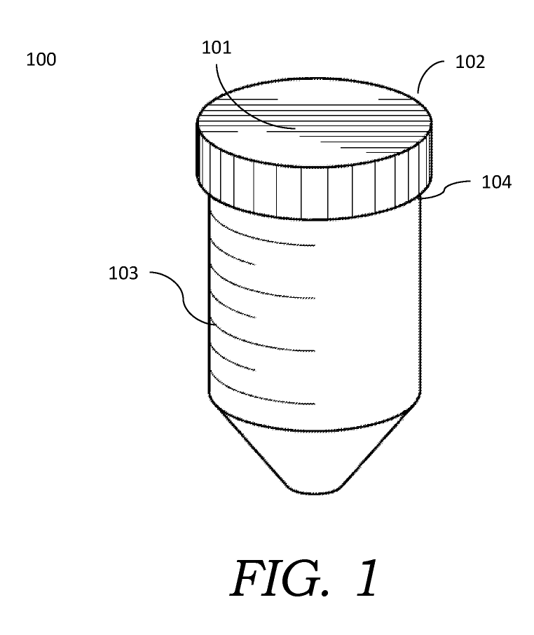

Turning to the figures of the present invention, various aspects are described. FIG. 1 presents a typical laboratory object 100 present in a laboratory setting. The laboratory object presented in FIG. 1, while not limiting, represents a sterile tube 103 for containing specimens. The tube comprises a lid 102 having a top surface 101, which can be attached to the tube via a threaded portion 104.

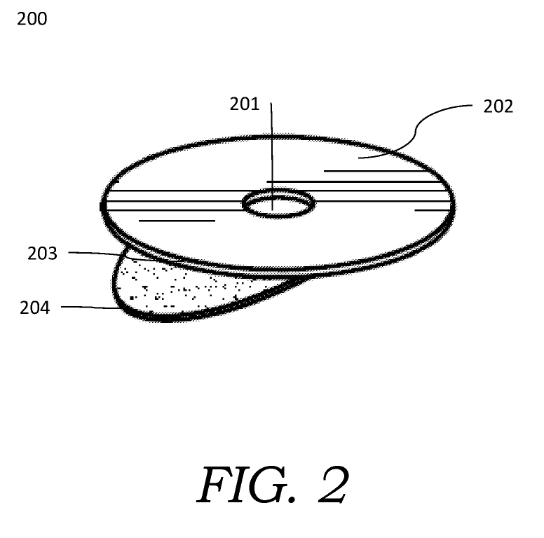

FIG. 2 presents an exemplary form of a magnet 200 which may be affixed to an object. The magnet 200 comprises a magnetized surface 202, as well as an adhesive surface 203. In this FIG. 2, the adhesive capability is a removable peel and stick adhesive, covered by a removable paper tab 204 to allow the magnet to be stored in a sterile fashion, removed and then placed upon the object of interest. In an alternative embodiment, the magnet may be a magnet receptive substrate comprising a non-ferrous material, which may be flexible in nature and lightweight. These magnet receptive substrates maybe quick mounting, such as with an adhesive, including for peel and stick applications. The magnets may have special features, such as a hole 201, which may be a slot, tab, or cutout for assisting in storage or organization while the magnets are not in use. In another embodiment, the magnets may be comprised of pressure-sensitive adhesive for press application to a surface. In the exemplary embodiment presented in FIG. 2, the magnet is then able to be affixed to a surface of an object such as a lid upon removal of the paper tab 204. In an alternative embodiment, the magnetic material comprises an adhesive that is a hydrogel, acrylic, or rubber based, each of which may be repositionable, and thus re-usable.

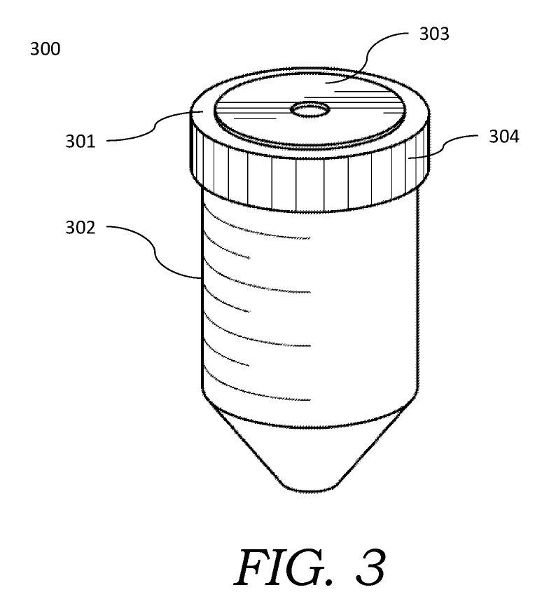

FIG. 3 presents a sterile specimen tube 300 comprising a magnet 303 affixed to a lid 301. The lid may be handled by grasping the side 304 and screwing or unscrewing the lid from the tube body 302. Once removed, the lid may be suspended from support surface of a stand and work may commence with the tube 302. Upon completing the use of the tube 302, the lid 301 may be removed from the stand by grasping its side 304 and re-attaching the lid 301 to the tube 302.

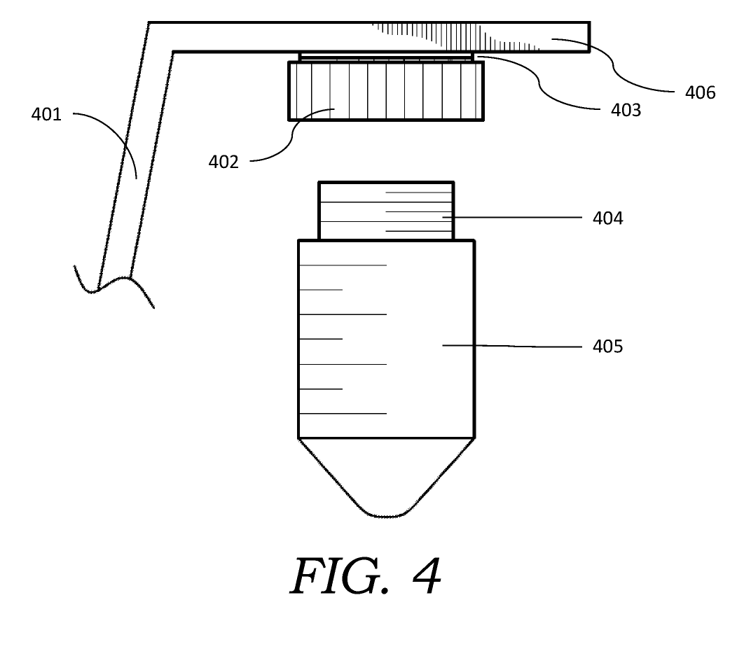

FIG. 4 presents a stand assembly suspending a lid 402 comprising a magnetic stand 401 having the magnetized lid 402 suspended from the lower portion of a horizontal arm or extension 406. The magnetized lid 402 further comprises a magnet 403 affixed to the upper surface of the lid 402. The tube 405 having a threaded portion 404 may be then attached to the lid 402 either while suspended from the stand's horizontal arm 406 or upon removal of the lid 402 by the user and then attached.

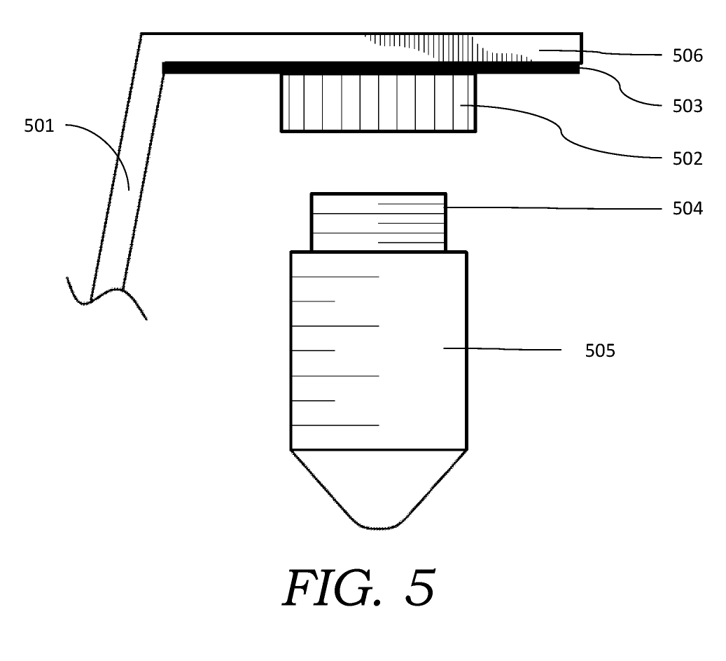

FIG. 5 presents a stand assembly suspending a lid of a laboratory object comprising a stand 501 having a horizontal extension or beam 506, wherein the extension comprises a magnet 503 or magnetized support surface, wherein a magnetic lid 502 may be positioned and suspended from the support surface while the sterile tube 505 is utilized or processed. The magnetic lid 502 may be comprised fully of metal or a magnetic material. Alternatively, the magnetic lid 502 may comprise a magnetic material inserted on the top surface of the lid 502. The tube 505 may further comprise a threaded portion 504, which is then capable of being received by the lid 502.

Those skilled in the art will recognize that the methods and systems of the present invention may be implemented in many manners and as such are not to be limited by the foregoing exemplary embodiments and examples. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A device, comprising: a sterile laboratory object and a support surface located near a potentially contaminated surface, wherein sterile laboratory object comprises a removably affixed magnetic material affixed to a portion thereof, and wherein the sterile laboratory object comprising the removably affixed magnetic material is capable of being suspended from a support surface located near a potentially contaminated surface without the sterile laboratory object contacting the potentially contaminated surface to maintain sterility of the sterile laboratory object.

20. The device of claim 19, wherein the laboratory object is selected from a group consisting of: glassware, vials, dishes, trays, tubes, flasks, bowls, crucibles, arrays, wells, plates, plastic ware, reactors, petri dishes, lids, covers, trays, plugs, stoppers, caps, clips, clamps, and any further removable portion thereof.

21. The device of claim 19, wherein the laboratory object is a lid of a culture dish.

22. The device of claim 19, wherein the removably affixed magnetic material is autoclavable.

23. The device of claim 19, wherein the removably affixed material is magnetized.

24. The device of claim 19, wherein the support surface is magnetized and capable of suspending a laboratory object comprising a magnetic material.
